(19) United States
(12) Patent Application Publication
(10) Pub. No.: US 2018/0337499 A1
(43) Pub. Date: Nov. 22, 2018

(54) BUS BAR AND METHOD FOR CONTACTING AN ELECTRIC MOTOR

(71) Applicant: Hanon Systems, Daejeon (KR)

(72) Inventors: Bernadette Goebbels, Köln (DE); Bernd Guntermann, Lennestadt (DE); Stephan Werker, Merzenich-Golzheim (DE)

(21) Appl. No.: 15/948,387

(22) Filed: Apr. 9, 2018

(30) Foreign Application Priority Data
May 17, 2017 (DE) 102017110696.0

(51) Int. Cl. H01R 25/16; H01R 43/04

(52) U.S. Cl. CPC H01R 25/162; H01R 43/04

(57) ABSTRACT

A bus bar (1) and a method for contacting an electric motor, addresses the problem of specifying a solution with which a simple, reliable and secure contacting of the electric motor is achieved. This problem is resolved at the device side thereby that on the first end (3) of the bus bar (1) a hole (5) is disposed that is undersized in comparison to the diameter of the feed-through contact (6). A method is provided wherein a bus bar (1) is provided which, on a first end (3) of the bus bar (1), comprises a hole (5) that is undersized compared to the diameter of the feed-through contact (6) and that the contacting of a feed-through contact (6) of an electric motor with the hole (5) of the provided bus bar (1) takes place in one operating step by press-fitting a stator (12) connected with the feed-through contacts (6).

The invention relates to a bus bar for contacting a feed-through contact of an electric motor, wherein the bus bar comprises a first end and a second end.

The invention relates also to a method for contacting a feed-through contact of an electric motor, wherein a bus bar is connected electrically conducting to the feed-through contact.

In the operation of one- or multi-phase electric motors for example that are disposed in a hermetically sealed housing, there is the necessity of supplying the motor with an operating current without any impairment of the impermeability of the system. It is known to realize for this purpose the supply of a required operating voltage or a required operating current via so-called feed-through contacts. Such a motor can, for example, be a refrigerant compressor in a motor vehicle.

DE 102015103053 A1 discloses an electric feed-through unit for the feed-through of electric contacts through a wall of a housing of an electric motor. The feed-through unit comprises a pin, comprised of an electrically conductive material, and a sleeve encompassing the pin. This description relates furthermore to a housing of an electric motor, which housing includes at least such electric feed-through unit as well as an electric motor comprising such housing.

The electric feed-through unit comprises a pin of an electrically conductive material encompassed by an electrically insulating sleeve. The pin includes an at least partially conical contact face for the region of a passage through the wall of the housing and, with the sleeve encompassing it, is disposed in an at least partially conical bore extending through the wall of the housing.

Advantageous in this proposed solution is that through the saving of assembly and mounting time and expenditures as well as parts costs it enables a very simple and favorable mounting of the motor components in the motor housing. It offers, moreover, a number of advantages compared to the use of conventional glass-to-metal seals (GTMS). The openings in the motor housing required for the electric feed-through units are small and lead to improved pressure resistance and rigidity of the motor housing. The cross sectional area to be sealed is also small and consequently results in lower leakage and permeation rates.

Such feed-through contacts must be electrically integrated on the motor side in the hermetic housing as well as also on the side outside of the hermetic housing.

Known in prior art is establishing this contacting via spring contact sleeves or spring contact elements. These spring contact sleeves or spring contact elements, in turn, are electrically conducting attached by being injected, soldered or welded on the line or bus bar carrying electric current. In this manner, for example for a three-phase electric motor, a structural unit for voltage and current supply is provided which comprises three bus bars with a spring contact sleeve each press-fit, soldered or welded onto a first end of a bus bar. The in each instance second end of a bus bar is provided such that it can, for example, be carried through a circuit board and be soldered to it. Such a multilayer circuit board for example supports the components required for activating the motor, which components can be associated with an inverter circuit.

Solutions are also known in prior art according to which spring contact sleeves or spring contact elements are integrated into the bus bar. This integration of the spring contact sleeves can be completed, for example, by injection, soldering or welding.

Such spring contact sleeves or spring contact elements, that are to establish an electrically conducting connection with very low transfer resistance as well as also enable tolerance compensation between the bus bar and the feed-through contact are disclosed, for example in DE 10 2004 017 659 A1.

The disadvantage of this prior art is that the lines or bus bars leading from the feed-through contact must each be equipped with a spring contact sleeve or a spring contact element.

Such spring contact sleeves or spring contact elements are parts that are complex in their mechanical production and must be connected with a bus bar in a separate assembly step. The acquisition of the spring contact sleeves or spring contact elements as well as also their assembly with or in the bus bar entail costs and require corresponding assembly time.

The expenditures in the production of a spring contact sleeve or of a spring contact element consist therein that, for example, spring steel must be punched out such that individual resilient blades are obtained.

This semi-finished product is rolled up in an additional production step and, for example, slid into a holding sleeve. Most frequently the spring sleeve is subsequently secured by retaining clips to prevent the leaves from shifting or falling out. In a further working operation the structure provided thus is subsequently connected to the bus bar, for example, by injection.

The demonstrated disadvantages show that there is a necessity for a suitable solution which, in contacting an electric motor, suffices without the element of a spring contact sleeve or a spring contact element and does not require the additional assembly step of connecting the spring contact sleeve or the spring contact element with the bus bar.

The invention addresses the problem of specifying an arrangement and a method for contacting an electric motor, the use of which achieves a simple, safe and reliable contacting of the electric motor. In addition, the assembly expenditures and the costs are also to be reduced.

This problem is resolved through a subject matter with the characteristics of Patent Claim 1 of the independent patent claims. Further developments are specified in the dependent Claims 2 to 5.

Provided is implementing the bus bar as a punched part for example of a conductive metal sheet. For example, in a first manufacturing step the bus bar can be punched out of a metal sheet. In a second manufacturing step the bus bar is bent at an angle of 90° at a second end to be connected to a circuit board. This bent end of the bus bar can be passed through an opening in the circuit board provided for this purpose and be soldered to a conductor track of the circuit board, for example on the side of the circuit board facing away from a motor.

For the establishment of an electrically conductive and mechanically stable contact between the bus bar and the feed-through contact the invention provides implementing the first end of the bus bar with a hole. This hole can be, for example, round or have any other suitable shape, such as a triangular or n-gonal or have the shape of a cloverleaf.

Independently of whether or not the hole is, for example, round, it is provided to implement the hole undersized, thus smaller than the diameter of the feed-through contact or feed-through pin that has a circular cross section.

For the case in which the feed-through contact has at its end projecting from the feed-through a square cross section, adaptation of the hole in the bus bar to this cross section can alternatively be carried out. In this case the hole is, for example, also implemented in square form wherein it is, again, undersized compared to the cross section of the feed-through contact.

In this way the secure connection between bus bar and feed-through contact is enabled when the bus bar is pushed and injected onto the contact.

To attain a larger contact surface area between the bus bar according to the invention and a feed-through contact, it is furthermore advantageous if the hole in the bus bar is expanded, for example using a means for peripheral flanging or similar means, by flanks which are formed about the hole. In this case the area with which the bus bar is connected with the feed-through contact is substantially no longer determined by the material thickness of the bus bar but rather by the flanks generated by the flanging. In such an implementation the inner diameter of the hole generated by the flanging is produced undersized, thus smaller than the diameter of the feed-through contact or pin to be contacted.

In the implementation with flanging flanks, as well as also without, it is provided to position the bus bar with the hole underneath the feed-through contact and subsequently to the push the feed-through contact into the bus bar and inject it. For this purpose, pressure is for example exerted onto the feed-through contact while the bus bar is held in position. It is also provided to carry out the injection process uniformly and at a controlled rate. A suitable arrangement with suitable control is provided for this purpose, which carries out the injection process uniformly and enables travel-force regulation.

Through this injection process, with its travel path, the applied force and the required time under control, cold welding between the surfaces of the feed-through contact and the bus bar in the contacted region is achieved. Moreover, through this control tearing of the cold-welded connection once established is avoided.

The invention provides a bus bar that, without additional parts such as a spring contact sleeve or a spring contact element, can be installed directly between a circuit board and a feed-through contact of a motor and electrically connects the circuit board with the feed-through contact.

For tolerance compensation it is also provided to work into the bus bar one or more curvatures or bends, for example using a press method. The bus bar consequently receives a region that extends in the form of an arc or a meander and, for example, is suited to compensate tolerances or to absorb or relieve mechanical stress resulting from thermal changes. Such tolerances are conventionally caused by manufacturing processes and affect, for example, the position of the feed-through contacts to a circuit board between which the bus bar is placed. Such tolerance compensation is in particular required in the case of an electric refrigerant compressor in a motor vehicle since here, in the course of normal function, temperature differences occur and mechanical stress must be compensated to ensure the reliable and safe function of the refrigerant compressor.

The problem is also resolved through a method with the characteristics according to Patent Claim 6 of the independent patent claims. Further developments are specified in the dependent Patent Claims 7 to 10.

In the following a specific method will be described for establishing a conductive, mechanically robust connection of the bus bar according to the invention with a feed-through contact in a motor. However, the installation or the injection of the bus bar is also possible without applying the method described in the following.

In preparation of the method for contacting an electric motor that comprises several of the above described feed-through contacts, each of which is to be connected electrically conductive with one bus bar according to the invention, a so-called holder plate is provided. This holder plate advantageously comprises indentations to receive the bus bars required for the contacting. The task of these indentations is to hold in position the bus bars placed in them while the processes of carrying out the method and assembly are completed. The holder plate can alternatively also be implemented without indentations. In this implementation appropriate holding means, such as one or several lateral delimitations or position pins, are provided for fixing the bus bars.

In addition, at the positions agreeing with the holes of the bus bar, placed in or on it, the holder plate has one counterbore per hole. These counterbores have a larger diameter than the diameter of the feed-through contact to be press-fit into the hole of the bus bar and therewith enable an unobstructed press-fit process.

For the case in which a three-phase electric motor is to be contacted with three feed-through contacts, the holder plate has three indentations or holders suitable for receiving three bus bars, into which the three bus bars are placed.

Also provided is a hermetically closable motor housing, or the particular part of a motor housing, that includes the bores, implemented for example in the shape of conical bores, for receiving the feed-through contacts. Also provided is a stator to be placed into the motor housing which has already been preassembled with the feed-through contacts to be press-fit into the bus bars. In a three-phase motor, for example, the stator is preassembled connected with three feed-through contacts.

At the start of the method for contacting an electric motor, which, in the following, will be denoted as press-fit process, the bus bars are placed into the holder plate at the positions provided for this purpose. In the following the motor housing, or the appropriate part of a motor housing, is aligned above the holder plate and placed onto the holder plate. The alignment takes place such that the bores or conical bores, worked for example into the motor housing for receiving the feed-through contacts, are positioned perpendicularly over the holes of the bus bars.

The stator with its preassembled feed-through contacts is furthermore disposed and aligned over the motor housing such that it can be slid into the motor housing and the holes of the bus bars are located in the extension of the feed-through contacts. The stator has conventionally an outer diameter that enables the stator being press-fit into the inner diameter of the motor housing, wherein the stator, after the press-fit has been completed, is held to be set in securely or is secured under pressure in the motor housing. Besides the feasibility of a press-fit, a method for example for a shrink-fit or a combination of press-fit and shrink-fit can also be applied.

To position the stator in the described position above the motor housing, for example, an appropriate retaining fixture is provided which is adapted to the stator and retains it securely.

By means of this retaining fixture the stator is embedded or press-fit into the motor housing. While the stator with the preassembled feed-through contacts is, for example, continuously press-fit into the motor housing, the distance between the feed-through contacts and the corresponding bores in the motor housing decreases continuously until the feed-through contact merges into the bores.

In the further course of the press-fit process the feed-through contacts reach the holes of the associated bus bars and are press-fit into these prefabricated holes. Due to the undersize of these holes, the feed-through contacts are pressed into the holes such that contacting, for example through cold welding, results. In such cold weldings metallic materials under high pressure are already connected with one another at ambient temperature such that the connection generated herein approximates a connection normally generated under “normal” welding.

When the retaining fixture has reached its end position, the press-fit process is completed. At the end of the press-fit process the stator has been pressed into the motor housing and the feed-through contacts as well are also held under press-fit in the bus bars.

The generated unit, comprised of motor housing, feed-through contacts and bus bars, is removed from the holder plate and can be submitted to a subsequent further assembly step.

As already known in prior art, a so-called feed-through unit comprises a pin or feed-through contact of an electrically conductive material and a sleeve encompassing the feed-through contact for the electric insulation of the feed-through contact against the motor housing. Such sleeves or insulation sleeves are provided to be set into the bores of the housing before starting the press-fit process or to supply the housing with the insulation sleeves already set into the bores.

It is also provided for the retaining fixture to be implemented such that it not only can exert force onto the stator to be press-fit but that the retaining fixture for example can also comprise elements which enable a direct force transmission onto the feed-through contacts to be press-fit. By exerting a direct force onto the feed-through contacts the connection between stator and feed-through contacts, already connected with the stator, is not significantly mechanically stressed during the press-fit process and consequently counteracts generated defects through too great a mechanical loading.

It is also provided for the bores in the housing of a motor, which serve for receiving the feed-through contacts, to be developed as conical bores.

The described method has the advantage that in a single press-fit process the stator can be pressed into the motor and the feed-through contacts can as well also be pressed into the bus bars, whereby the assembly time is shortened and the assembly expenditures are reduced. These advantages certainly also have a positive effect on the production costs.

Further details, characteristics and advantages of embodiments of the invention are evident in the following description of embodiment examples with reference to the associated drawing. Therein depict:

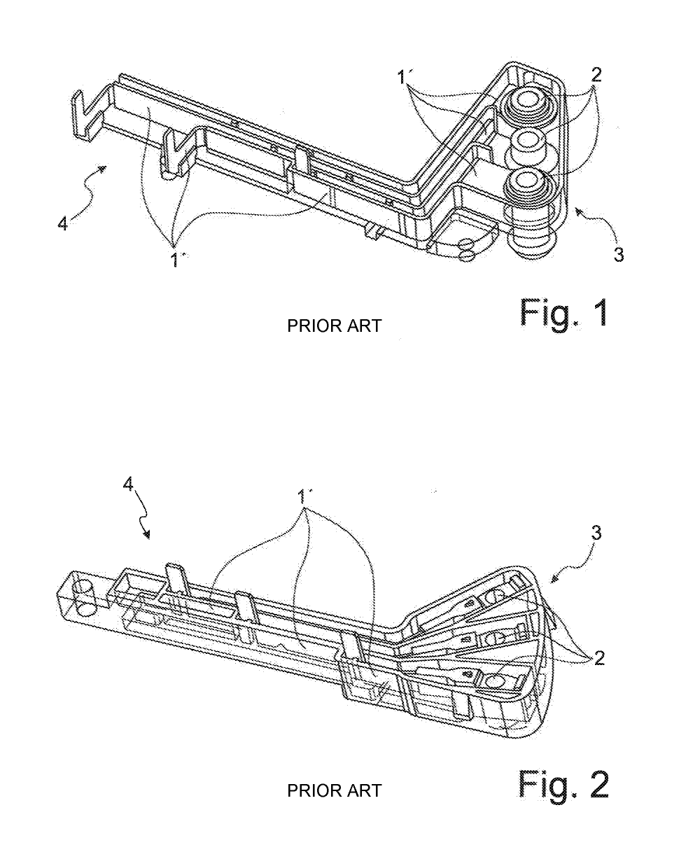

FIG. 1 a prior art unit, comprised of three bus bars with press-fit spring contact sleeves, provided for contacting a motor,

FIG. 2 an alternative prior art unit having three bus bars for contacting an electric motor, each with integrated spring contact sleeves,

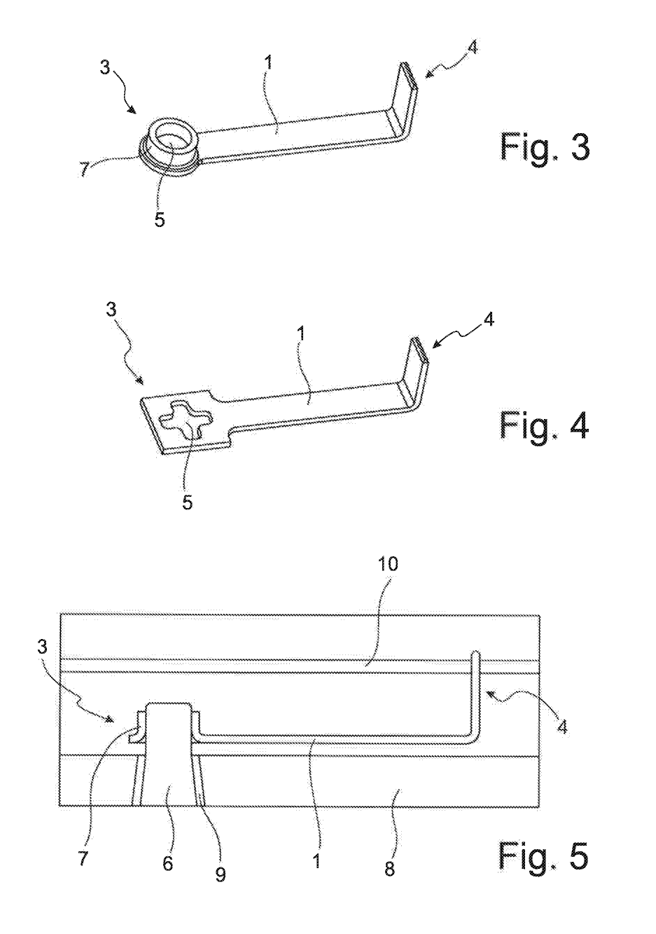

FIG. 3 an embodiment of a bus bar according to the invention,

FIG. 4 an alternative embodiment of a bus bar according to the invention,

FIG. 5 a sectional representation through a feed-through contact with a pressed-on bus bar,

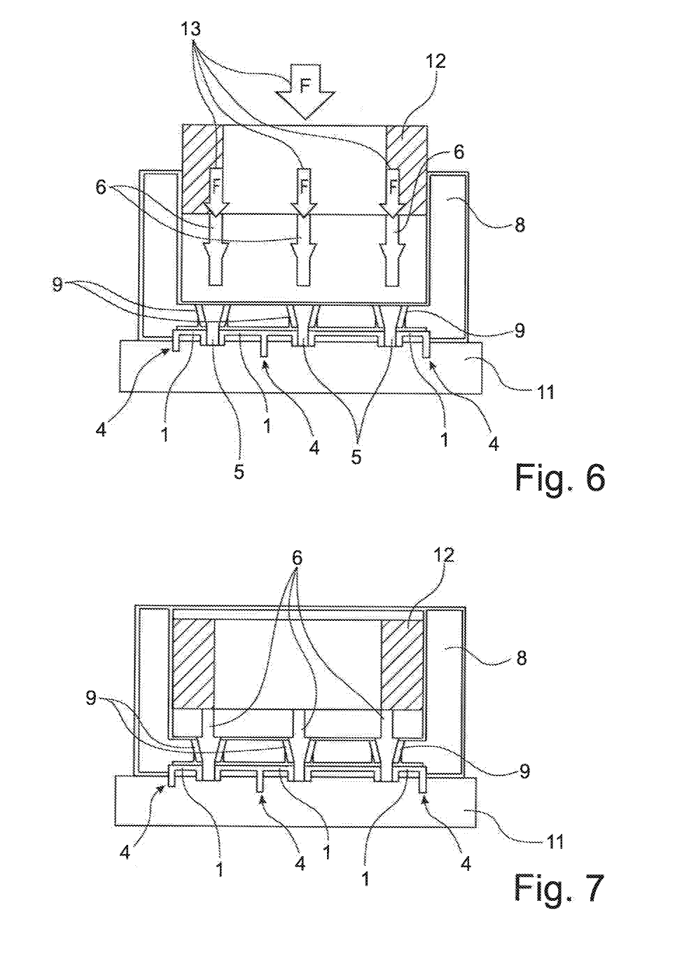

FIG. 6 a device for carrying out the method for contacting an electric motor with the bus bars according to the invention, in a first state,

FIG. 7 the device for carrying out the method for contacting an electric motor with the bus bars according to the invention, in a second state, and

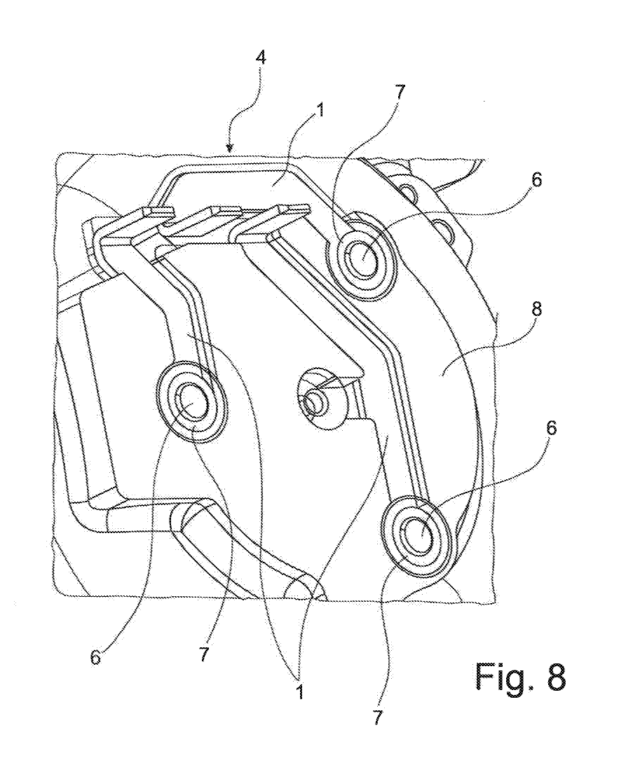

FIG. 8 a perspective representation of a motor housing with feed-through contacts and pressed-on bus bars.

In FIG. 1 is depicted a unit intended for contacting a motor, comprised of three bus bars 1′ each with press-fit spring contact sleeves 2 of prior art. Each of the three prior art bus bars 1′ comprises at a first end 3 a spring contact sleeve 2 attached electrically conductive to the bus bar 1′. These spring contact sleeves 2 can be connected with the bus bar 1′ for example by welding, soldering or bolting.

At the particular second end 4 each of the bus bars 1′ has an end which is suitable, for example for connecting with a, not shown, circuit board 10. Such electrically conductive connection can be established, for example, by soldering or bolting.

The three bus bars 1′ are disposed in a common receiver or a housing which insulates the bus bars 1′ against each other. The spring contact sleeves 2 of the bus bars 1′ are slid onto the feed-through contacts 6 of a motor and in this way connect a circuit board 10 controlling the motor with the feed-through contacts 6, which are contacted, for example, with a stator having several stator windings. To the motor, consequently, a control voltage or a control current can be supplied.

In FIG. 2 an alternative prior art unit having three bus bars 1′ for contacting an electric motor is shown, each including integrated spring contact sleeves 2. In this implementation the spring contact sleeves 2 are integrated at a first end 3 of the bus bar 1′ in a special receiver and connected with the bus bars 1′.

However, the implementations shown in FIGS. 1 and 2 have the disadvantage that the lines or bus bars to be contacted with a feed-through contact 6 must each be equipped with a spring contact sleeve 2 or a spring contact element at a first end 3, which makes these solutions complex and expensive.

In FIG. 3 a first embodiment of a bus bar 1 according to the invention is depicted. It is provided to punch the bus bar 1 out of, for example, a conductive metal sheet of appropriate thickness or strength and to provide it at its first end 3 with a hole 5. In a later press-fit process this hole 5 serves for receiving a, not shown, feed-through contact 6. One or several of these feed-through contacts 6 having a circular cross section are placed according to prior art in corresponding bores in housing 8 of a motor in order to establish an electrical connection between stator windings located in the motor and an activating unit.

The second end 4 of bus bar 1 can optionally be angled and/or developed into a contact which is electrically connected with the control unit activating the motor.

The hole 5 in the bus bar 1 can be, for example, round or oval. Independently of the precise form of hole 5, it is developed such that the hole 5 is undersized with respect to the feed-through contact 6. The hole 5 consequently has an inner diameter that is less than the outer diameter of the feed-through contact 6 to be contacted.

It is in this way possible to attain a secure connection between bus bar 1 and the feed-through contact 6 when, during a press-fit process, the bus bar 1 is slid or pressed onto the contact 6.

The bus bar 1 depicted in FIG. 3 has in the proximity of the hole 5 a formed-out margin or flange 7, such as is known, for example, from the field of flange forming. Through the out-forming of this flange 7 the area of the contact face forming between the bus bar 1 according to the invention and a feed-through contact 6 is enlarged and therewith the transfer resistance between the bus bar 1 and the feed-through contact 6 is decreased.

Such flange 7 can, for example, also be developed about the hole 5 using a means for flanging or a similar means. In the dimensioning of flange 5 is provided that the inner diameter of the developing hole 5 with flange 7 has the above described undersize.

For shaping the form of the hole 5 other suitable shapes, such as a triangular or an n-gonal or a cloverleaf structure can be utilized. An example of an implementation of hole 5 in the form of a cloverleaf is depicted in FIG. 4.

FIG. 5 is a sectional representation in which the bus bar 1 has been pressed with a flange 7, formed out on the first end 3 in the proximity of the hole 5, onto a feed-through contact 6 and in this way has been connected mechanically stable and electrically conducting with the feed-through contact 6. Evident is the feed-through contact 6, disposed in a bore introduced in a motor housing 8, which is electrically insulated against the motor housing by means of an insulation sleeve 9.

The second end 4 of the bus bar 1 is bent at an angle of, for example, 90° and is thus angular or angled. This angular end of bus bar 1 can be conducted through an opening provided for this purpose in the circuit board 10 and be soldered to a conductor track of the circuit board 10, for example, on the side of the circuit board 10 facing away from a motor housing 8. The circuit board 10 is only shown symbolically and can receive the components or structural elements, that may be associated with an inverter, necessary for activating the motor,

FIG. 6 shows a device for carrying out the method for contacting an electric motor (press-fit process) with the bus bars 1 according to the invention in a first state. This state corresponds to the start of the press-fit process in which the required parts have been provided and brought into their corresponding positions.

To prepare the process a holder plate 11 is supplied. This holder plate 11 comprises, for example, indentations for receiving the bus bars 1 required for the contacting. These indentations have the task of holding the emplaced bus bars 1 in place while the press-fit process is in process. Alternative means for fixing the bus bars 1 on the holder plate 11 are feasible.

The holder plate 11 has, for example, counterbores whose position agrees with the holes 5 of the emplaced bus bars 1. With respect to their particular diameter, these counterbores are larger than the diameter of the feed-through contact 6 to be press-fit into hole 5 of the bus bar 1 and enable thus a press-fit process without the feed-through contact 6 coming into contact with the holder plate 11.

FIG. 6 shows the case in which a three-phase electric motor is to be contacted with three feed-through contacts 6. The holder plate 11 consequently has three indentations suitable for receiving three bus bars 1, into which the three bus bars 1 have been placed. FIG. 6 shows only a basic depiction to explain the press-fit process and does not precisely show the precise course of the emplaced bus bars 1. However, clearly shown are the three downwardly angled second ends of the three bus bars 1 as well as the three first ends 3 with their holes 5.

Before the start of the press-fit process a hermetically closable motor housing 8 or an appropriate part of a motor housing 8 is also provided which includes the bores for receiving the feed-through contacts 6. Into these bores, which are conical in shape, the insulation sleeves 9 are emplaced or have already been secured in place.

As shown in FIG. 6 a stator 12 to be installed in the motor housing 8 is also provided, which has already been preassembled with the feed-through contacts 6 to be press-fit into the bus bars 1. The stator 12 in the depicted three-phase motor is already preassembled with three feed-through contacts 6.

At the start of the press-fit process the bus bars 1 are placed into the holder plate 11 at the positions provided therefor. The motor housing 8, or the appropriate part of a motor housing 8, is subsequently aligned above the holder plate 11 and placed onto the holder plate 11. The alignment is carried out such that the conical bores for receiving the feed-through contacts 6 and worked into the motor housing 8 are positioned perpendicularly above the holes 5 of the bus bars 1.

Stator 12 is furthermore disposed with its preassembled feed-through contacts 6 by means of a, not shown, retaining fixture above the motor housing 8 and aligned such that it can be slid into the motor housing 8. In addition, the alignment of stator 12 takes place such that the feed-through contacts 6 in the subsequent press-fit process will reach the holes 5 of the bus bars 1. The holes 5 are thus located in the imaginary extension of the feed-through contacts 6.

The retaining fixture is formed such that it can simultaneously exert forces 13 onto the points indicated by arrow tips. Through an external force 13 acting onto the retaining fixture and its transmission into these points, the stator 12 and the feed-through contacts 6 are shifted into the direction of the holder plate 11 and in this way sunk or pressed into the motor housing 8.

While the stator 12 with the preassembled feed-through contacts 6 is, for example, continuously pressed into the motor housing 8, the distance between the feed-through contacts 6 and the corresponding bores in motor housing 8 continuously decreases further until the feed-through contacts 6 merge into the bores as well as into the insulation sleeves 9 disposed in the bores.

In the further course of the press-fit process the feed-through contacts 6 reach the holes 5 of the associated bus bars 1 and are pressed into these prefabricated holes 5. Due to the undersize of the holes 5, the feed-through contacts 6 are contacted with the bus bars 1 by means of cold welding.

When the retaining fixture has reached its end position, the press-fit process is completed and the stator 12 has been pressed into the motor housing 8 and the feed-through contacts 6 as well have also been pressed into the holes 5 of the bus bars 1. The completed press-fit process, in which the retaining fixture has reached its end position, is depicted in FIG. 7.

The generated unit comprised of motor housing 8, feed-through contacts 6 and bus bars 1 is removed from the holder plate 11. Therewith the press-fit process is completed and an electrically conducting connection has been established between the bus bars 1, the feed-through contacts 6 and the windings of stator 12. Subsequently a circuit board 10, for example, can additionally be applied and soldered to the second ends 4 of bus bars 1.

FIG. 8 shows a perspective representation of a motor housing 8 with feed-through contacts 6 and pressed-on bus bars 1. In the depiction three bus bars 1 are disposed insulated against the motor housing 8 in corresponding channels provided in motor housing 8. Each of the bus bars 1 has at its first ends 3 in the proximity of the hole 5 a flange 7 and is depicted as already pressed onto the associated feed-through contact 6. The particular second ends 4 of bus bars 1 are bent at right angles and terminate next to one another in the upper left of FIG. 8. It is intended to contact the second ends 4, prepared and disposed in this manner, with a circuit board 10, not shown. As can be seen in FIG. 8, the form of the bus bar can deviate from a straight course and be adapted to structural requirements.

### LIST OF REFERENCE NUMBERS

1, 1′ Bus bar

2 Spring contact sleeve

3 First end

4 Second end

5 Hole

6 Feed-through contact

7 Flange/Margin

8 Motor housing

9 Insulation sleeve

10 Circuit board

11 Holder plate

12 Stator

13 Force (F)

1.-10. (canceled)

11. A bus bar for contacting a feed-through contact of an electric motor, wherein the bus bar has a first end and a second end, wherein on the first end of the bus bar a hole is disposed that is undersized compared to the diameter of the feed-through contact.

12. A bus bar as in claim 11, wherein at the hole a flange encompassing the hole is disposed.

13. A bus bar as in claim 11, wherein the hole is round, oval, n-gonal or has the form of a cloverleaf.

14. A bus bar as in one of claims 11, wherein the second end of the bus bar is disposed bent at an angle of 30°, 45° or 90°.

15. A bus bar as in one of claims 11, wherein the second end of the bus bar is disposed connected to conductor tracks of a circuit board.

16. A method for contacting a feed-through contact of an electric motor, wherein a bus bar is connected electrically conducting with the feed-through contact, wherein a bus bar is provided which at a first end of the bus bar comprises a hole being undersized in comparison to the diameter of the feed-through contact and that the contacting of a feed-through contact of an electric motor with the hole of the provided bus bar is carried out in an operation step comprising the press-fitting of a stator connected with the feed-through contact.

17. A method as in claim 16, wherein the bus bar is provided with a flange encompassing the hole.

18. A method as in claim 16, wherein the bus bar is provided with a curvature or a bend for the purpose of tolerance compensation.

19. A method as in one of claims 16, wherein the bus bar is provided with a second end bent at an angle of 30°, 45° or 90°.

20. A method as in one of claims 16, wherein the bus bar is contacted with its first end across the feed-through contact with a stator winding of a motor and with its second end with a conductor track of a circuit board, wherein on the circuit board the components required for activating the motor are disposed that provide an inverter circuit.

21. A method as in claim 17, wherein the bus bar is contacted with its first end across the feed-through contact with a stator winding of a motor and with its second end with a conductor track of a circuit board, wherein on the circuit board the components required for activating the motor are disposed that provide an inverter circuit.

22. A method as in claim 18, wherein the bus bar is contacted with its first end across the feed-through contact with a stator winding of a motor and with its second end with a conductor track of a circuit board, wherein on the circuit board the components required for activating the motor are disposed that provide an inverter circuit.

23. A method as in claim 17, wherein the bus bar is provided with a curvature or a bend for the purpose of tolerance compensation.

24. A method according to 17, wherein the bus bar is provided with a second end bent at an angle of 30°, 45° or 90°.

25. A method according to 18, wherein the bus bar is provided with a second end bent at an angle of 30°, 45° or 90°.

26. A bus bar as in one of claims 12, wherein the second end of the bus bar is disposed bent at an angle of 30°, 45° or 90°.

27. A bus bar as in one of claims 13, wherein the second end of the bus bar is disposed bent at an angle of 30°, 45° or 90°.

28. A bus bar as in one of claims 12, wherein the second end of the bus bar is disposed connected to conductor tracks of a circuit board.

29. A bus bar as in one of claims 13, wherein the second end of the bus bar is disposed connected to conductor tracks of a circuit board.

30. A bus bar as in one of claims 14, wherein the second end of the bus bar is disposed connected to conductor tracks of a circuit board.
